(19) United States
(12) Patent Application Publication
(10) Pub. No.: US 2025/0065796 A1
(43) Pub. Date: Feb. 27, 2025

(54) RECREATIONAL VEHICLE AND POP-UP ROOF

(71) Applicant: Thor Tech, Inc., Elkhart, IN (US)

(72) Inventors: Alexander Kasteleiner, Greifenberg (DE); Jens Kromer, Achern (DE); Olaf Sackers, Sulz (DE)

(73) Assignee: Thor Tech, Inc., Elkhart, IN (US)

(21) Appl. No.: 18/813,981

(22) Filed: Aug. 23, 2024

(30) Foreign Application Priority Data
Aug. 25, 2023 (DE) 10 2023 122 938.9

(51) Int. Cl. B60P 3/39; B60J 7/16

(52) U.S. Cl. CPC B60P 3/39; B60J 7/165

(57) ABSTRACT

Pop-up roof for leisure vehicles, in particular motorhomes and/or camper vans and/or leisure vehicles based on high-roof station wagons, with a frame and at least one access opening which allows access through the frame. It is proposed that a bed construction is provided in that the bed structure is guided along a longitudinal direction at least indirectly on the frame, in that the bed structure is guided along the longitudinal direction beyond the frame into a cantilevered position. The bed construction and the frame are designed in such a way that in the cantilevered end position the access opening in the frame next to the bed structure is unobstructed. Furthermore, a recreational vehicle with such a pop-up roof is indicated.

### BACKGROUND

The invention relates to a recreational vehicle, in particular a motorhome and/or a campervan. In particular, the invention relates to a vehicle based on a high roof recreational vehicle.

A mobile inflatable housing for a vehicle roof is known from EP 4 206 035 A1. Here, an access opening is formed in the vehicle roof.

### BRIEF SUMMARY

If the recreational vehicle only has small roof dimensions, a mattress base or similar will be in the way when climbing onto the roof. It is conceivable that the mattress base can be folded away to allow access.

The object of the invention is to provide a pop-up roof for a recreational vehicle and a Recreational vehicle, which are of improved design. In particular, it is a task of the invention to provide a pop-up roof for a recreational vehicle and a recreational vehicle in which a relatively large storage area can be realized with a particularly limited interior space of the recreational vehicle and at the same time a storage space for the transport of bulky goods is made possible.

The problem is solved by a pop-up roof with the features of independent patent claim 1 and by a leisure vehicle with the features of patent claim 10. Advantageous further developments of the invention are given in the subclaims.

The problem is solved by a pop-up roof for recreational vehicles, in particular motorhomes and/or camper vans and/or recreational vehicles based on high-roof station wagons, with a frame and at least one access opening which allows access through the frame, wherein a bed construction wherein the bed structure is guided along a longitudinal direction at least indirectly on the frame, wherein the bed structure is displaceable along the longitudinal direction beyond the frame into a projecting end position, and wherein the bed structure and the frame are designed such that in the cantilevered end position the bed structure and the frame are displaceable along the longitudinal direction. The access opening in the frame next to the bed construction is released.

Furthermore, the task is performed by a leisure vehicle, in particular a motorhome and/or a campervan and/or a recreational vehicle based on a high-roof station wagon, with such a pop-up roof.

It is advantageous that a roof shell is provided and that the bed structure is arranged in a normal position on the frame when the roof shell is closed, in which the bed construction is at least not pushed significantly beyond the frame in the direction of the projecting end position. This enables a compact design of the pop-up roof in the closed state, which allows installation even with a comparatively short roof length. Despite the short roof length, a roof ascent can then be realized.

It is advantageous that the bed construction is designed as a frame-shaped bed construction. This enables advantageous guidance. A lightweight design can be achieved.

It is advantageous that a rail guide is formed between the bed construction and the frame. This enables a robust and advantageously resilient design. Furthermore, functionality can also be guaranteed in the event of temperature fluctuations and/or different exposure to sunlight.

It is advantageous that the bed construction has a first longitudinal strut and a second longitudinal strut, that a first rail is provided on the first longitudinal strut, that a second rail is provided on the second longitudinal strut, that the frame has a first longitudinal side, which has a first guide receptacle, and a second longitudinal side, which has a second guide receptacle, second longitudinal side, which has a second guide receptacle, and that the bed construction is guided in the frame by the first rail engaging in the first guide receptacle and the second rail engaging in the second guide receptacle. This enables a robust and advantageously resilient design. Furthermore, a mode of operation can also be achieved with temperature fluctuations and/or with different levels of sunlight can be guaranteed.

It is advantageous that the first rail runs horizontally and extends vertically through the first guide holder and that the second rail runs horizontally and extends vertically through the second guide holder. This ensures a robust guidance is possible. This can also be combined with additional functionality, in particular swiveling up the bed construction.

It is advantageous for the bed structure to have at least one buckling point, with a first lifting strut of the bed structure and a second lifting strut of the bed structure having at least one buckling point. Bed construction can be angled at the bend in such a way that part of the bed construction can be pivoted upwards. This allows, for example, greater headroom to be created for people sitting or possibly standing in the interior of the leisure vehicle.

It is advantageous that the upwardly pivoted part of the bed structure leaves at least one area around the access opening free. This means that an area in the leisure vehicle that is used for climbing up can also be used advantageously for sitting or standing at a greater height in the interior.

It is advantageous that the part of the bed construction can be pivoted upwards at least when the bed construction is arranged in the cantilevered end position. This allows additional headroom to be gained, as the bending point is then further away from the seated or standing person, so to speak.

Further advantages and details of the invention are explained in more detail with reference to the embodiment example shown in the schematic figures.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1A leisure vehicle with a pop-up roof according to an embodiment example in an excerpt-wise, schematic, spatial representation, whereby a view from the side at the rear with the pop-up roof open is shown and whereby additional elements, such as a covering of the pop-up roof, are not shown;

FIG. 2 the recreational vehicle shown in FIG. 1, with a bed structure partially swiveled upwards;

FIG. 3 the recreational vehicle shown in FIG. 1, with a bed element, in particular a bed support, is supported on a frame by means of the bed structure;

FIG. 4 the recreational vehicle shown in FIG. 3, whereby the bed construction is adjusted to a cantilevered end position so that an access opening is created;

FIG. 5 the recreational vehicle shown in FIG. 4, with the bed structure partially folded upwards from the cantilevered end position;

FIG. 6 shows the recreational vehicle shown in FIG. 5 in an excerpted, schematic representation from the viewing direction marked V; and

FIG. 7 the recreational vehicle according to the design example, with the pop-up roof closed.

### DETAILED DESCRIPTION

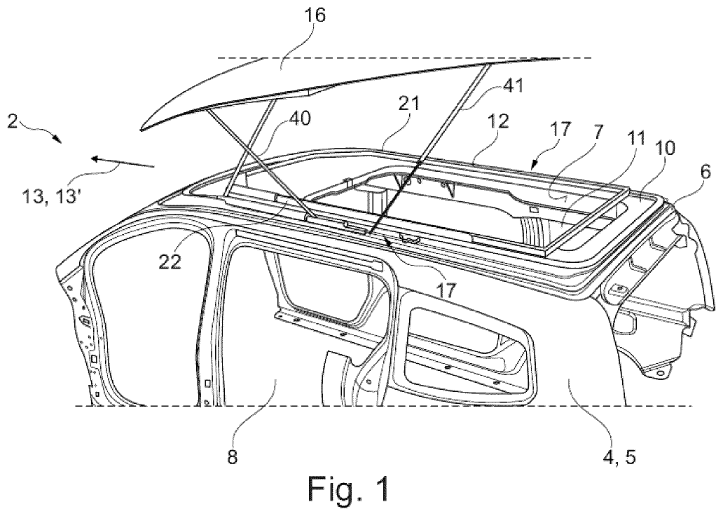

FIG. 1 shows a leisure vehicle 1 with a pop-up roof 2 according to an embodiment example in an excerpt-wise, schematic, spatial representation, wherein a view from the side at the rear with the pop-up roof 2 open is shown and wherein additional elements, such as a covering of the pop-up roof, are not shown.

However, suitable modifications are possible. For example, the roof 6 can be fitted with a suitable roof cut-out 7 is provided to allow access to the pop-up roof 2 and to enable a higher headroom in the interior 8 of the leisure vehicle 1 if necessary.

The pop-up roof 2 has a frame 10 and an access opening 11. The access opening 11 is located in the roof cut-out 7. The access opening 11 enables a person to climb through the frame 10 into the open pop-up roof 2.

Furthermore, the pop-up roof 2 has a bed structure 12. The bed structure 12 is guided along a longitudinal direction 13 on the frame 10.

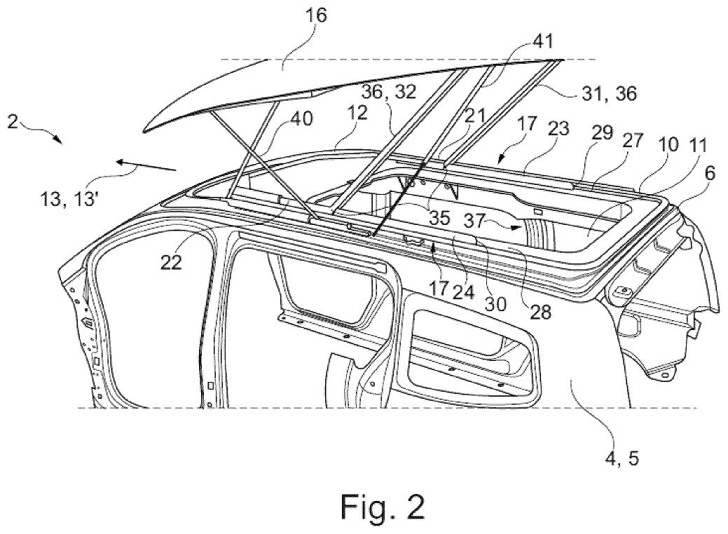

The recreational vehicle 1 and the pop-up roof 2 are also described further below with reference to FIGS. 2 to 7.

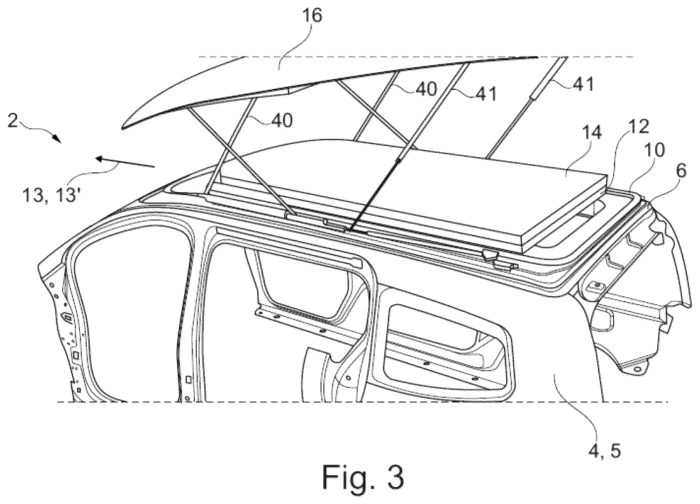

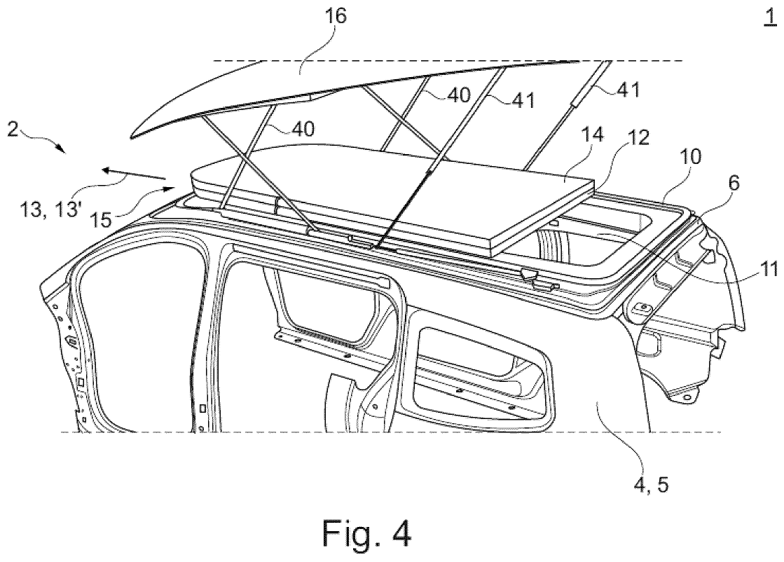

FIG. 2 shows the recreational vehicle 1 shown in FIG. 1, with the bed structure 12 partially swung upwards. Furthermore, FIG. 3 shows the recreational vehicle 1 shown in FIG. 1, wherein a bed element 14, in particular a bed support 14, is supported on a frame 10 by means of the bed structure. In addition, FIG. 4 shows the leisure vehicle 1 shown in FIG. 3, wherein the bed structure 12 is pivoted into and adjusted to the projecting end position 15 so that the access opening 11 is unobstructed.

The bed structure 12, which is guided along the longitudinal direction 13 on the frame 10, can, in this embodiment example, be guided along the longitudinal direction 13, which in this embodiment example is guided along the longitudinal direction 13 on the frame 10.

In the example shown here, the end position is the same as the direction of travel 13′ and can even be moved beyond the frame 10 into the cantilevered end position 15.

The bed structure 12 and the frame 10 are designed, in particular with regard to their geometric dimensions, so that in the cantilevered end position 15 the access opening 11 in the frame 10 is released next to the bed structure 12. The access opening 11 is therefore through the frame 10 and next to the bed structure 12.

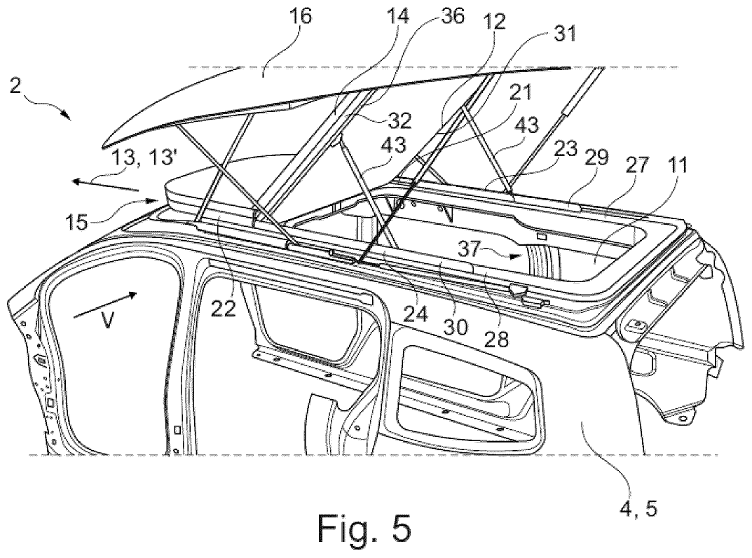

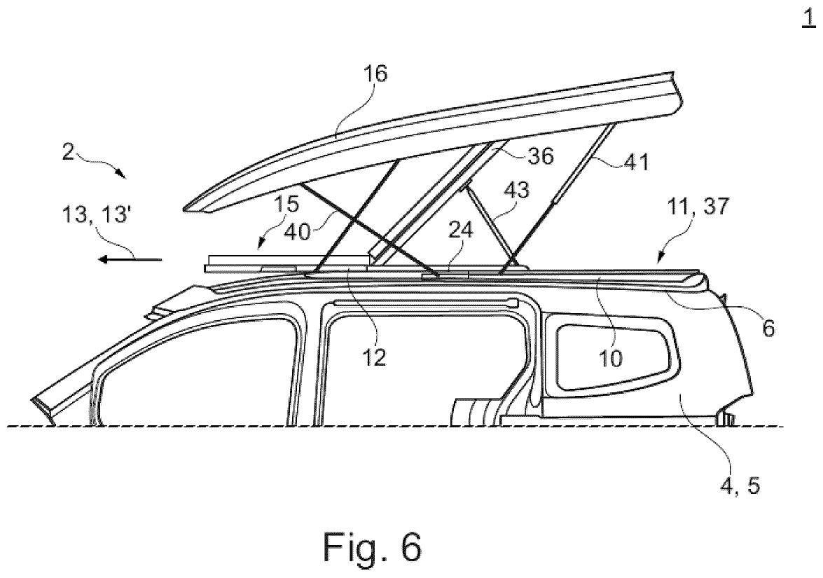

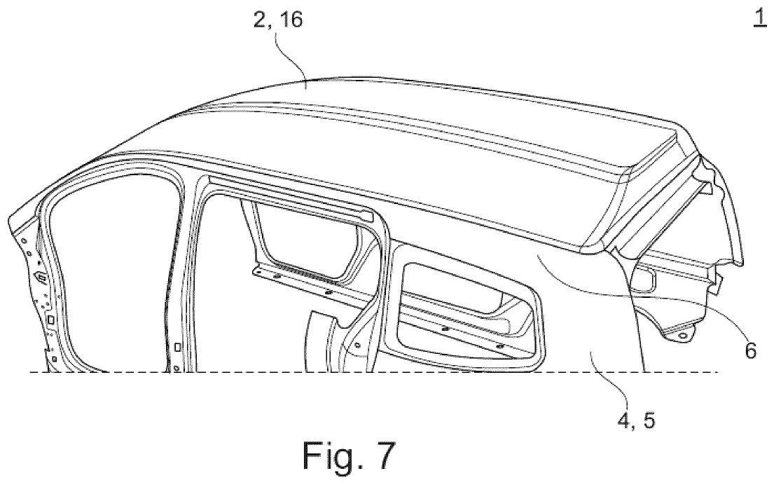

FIG. 5 shows the recreational vehicle 1 shown in FIG. 4, with the bed structure 12 made of the projecting end position 15 is partially folded upwards. FIG. 6 also shows the leisure vehicle 1 shown in FIG. 5 in an excerpted, schematic representation from the viewing direction marked V. FIG. 7 also shows the recreational vehicle 1 according to the embodiment example, with the pop-up roof 2 closed.

The pop-up roof has a roof shell 16. When the roof shell 16 is closed (FIG. 7), the bed structure 12 is arranged in a normal position 17 on the frame 10 as shown in FIG. 3. In the normal position, the bed structure 12 does not extend beyond the frame 10 in the direction of the projecting roof shell end position 15. This allows the roof shell 16 to be closed.

The bed construction 12 is designed as a frame-shaped bed construction 12. A rail guide 17 is formed on both sides between the bed structure 12 and the frame 10.

The bed structure 12 comprises a first longitudinal strut 21 and a second longitudinal strut 22. A first rail 23 is provided on the first longitudinal strut 21, which in this embodiment example is designed as a narrow, continuous strip. A second rail 24 is provided on the second longitudinal strut 22, which in this embodiment example, the rail is designed as a narrow, continuous strip.

The frame 10 comprises a first longitudinal side 27 and a second longitudinal side 28, which are associated with the longitudinal struts 21, 22 of the frame 10. The first longitudinal side 27 has a first guide receptacle 29. The second longitudinal side 28 has a second Guide holder 30.

The first rail 23 engages in the first guide mount 29. The second rail 24 engages in the second guide holder 30. The first rail 23 and the second rail 24 each run horizontally. Furthermore, the first rail 23 vertically through the first guide mount 29. In addition, the second rail 24 extends vertically through the second guide mount 30.

In this embodiment example, the bed structure 12 is placed on the frame 10 when the bed structure 12 is not bent. Lifting struts 31, 32 of the bed structure 12 is aligned horizontally, as shown in FIGS. 1, 3, 4.

The bed construction 12 has the kink point 35. When the bed structure 12 is bent at the bend point 35, a part 36 of the bed structure 12 is pivoted upwards. The lifting struts 31, 32 are then swung upwards at the bend point 35, as shown in FIGS. 2, 5 and 6.

The upwardly pivoted part 36 of the bed structure 12 opens up an area 37 around the access opening 11. This enables a higher standing or sitting height in the interior 8 of the leisure vehicle 1.

In addition, the part 36 of the bed structure 12 can also be pivoted upwards, or at least when the bed structure 12 is arranged in the cantilevered end position 15, as shown in FIG. 5. This further improves the headroom.

The roof shell 16 can be supported on the frame 10 by means of suitable roof rods 40, in particular cross rods 40. Furthermore, at least one actuating element 41, in particular a gas pressure spring 41, can be provided to facilitate the opening of the pop-up roof 2 and then keep it open. In addition, lifting elements 43, which can be designed as gas pressure springs, can be provided, which serve to lift the part 36 of the bed structure 13 and keep it raised.

The invention is not limited to the embodiments described.

What is claimed is:

1. A pop-up roof for recreational vehicles with a frame and at least one access opening, which provides access to the roof by the frame, wherein:
a bed structure is provided;
the bed structure is guided along a longitudinal direction at least indirectly on the frame;
the bed structure is guided along the longitudinal direction via the frame;
the frame can be displaced out into a projecting end position; and
the bed structure and the frame are designed in such a way that in the projecting end position the access opening in the frame next to the bed structure is released.

2. The pop-up roof according to claim 1, wherein a roof shell is provided and the bed structure is arranged in a normal position on the frame when the roof shell is closed, in which the bed structure does not at least substantially protrude beyond the frame and is pushed out of the frame in the direction of the projecting end position.

3. The pop-up roof according to claim 1, wherein the bed construction is designed as a frame-shaped bed construction.

4. The pop-up roof according to claim 1, wherein a rail guide is formed between the bed structure and the frame.

5. The pop-up roof according to claim 4, wherein the bed structure has a first longitudinal strut and a second longitudinal strut, in that a first rail is provided on the first longitudinal strut, in that a second rail is provided on the second longitudinal strut, in that the frame has a first longitudinal side, the second longitudinal side is provided on the first longitudinal strut and the second longitudinal strut is provided on the second longitudinal strut has a first guide receptacle and a second longitudinal side, which has a second guide receptacle, and in that the bed structure is guided in the frame by the first rail engaging in the first guide receptacle and the second rail engaging in the second guide receptacle.

6. The pop-up roof according to claim 5, wherein the first rail runs horizontally and extends vertically through the first guide receptacle, and the second rail runs horizontally through the second guide receptacle and extends vertically through the second guide holder.

7. The pop-up roof according to claim 1, wherein the bed structure has at least one buckling point, and a first lifting strut of the bed structure and a second lifting strut of the bed structure can be bent at the bending point in such a way that a part of the bed structure can be pivoted upwards.

8. The pop-up roof according to claim 7, wherein the upwardly pivoted part of the bed structure exposes at least one region around the access opening.

9. The pop-up roof according to claim 7, wherein the part of the bed structure can be pivoted upwards at least when the bed structure is in the cantilevered end position.

10. A recreational vehicle with a pop-up roof according to claim 1.
